(19) United States
(12) Patent Application Publication
(10) Pub. No.: US 2011/0031862 A1
(43) Pub. Date: Feb. 10, 2011

(54) SHELVING UNIT, IN PARTICULAR FOR REFRIGERATED INSTALLATIONS

(75) Inventors: Jean-Gerard Leconte, Courbevoie (FR); Francois Vardon, Queretaro (MX)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN GLASS FRANCE, Courbevoie (FR)

(21) Appl. No.: 12/935,920

(22) PCT Filed: Mar. 25, 2009
(86) PCT No.: PCT/FR09/50517

§ 371 Date: Oct. 1, 2010

(30) Foreign Application Priority Data
Apr. 9, 2008 (FR) 0852393

(51) Int. Cl. F25D 25/02; A47B 96/02; F16M 13/02; B23P 19/04

(52) U.S. Cl. 312/408; 211/134; 248/213.2; 29/428

(57) ABSTRACT

A shelving unit for a cabinet, for example a refrigerator or similar cabinet, including a panel supporting articles and a frame or part of a frame gripping the panel by its actual surrounding part, the frame arranged to allow the shelving unit to be mounted in a chassis of the cabinet. At least one securing member for the panel is provided in its bottom part, the securing member includes a rider configured to overlap a protuberance or rib of the frame, extending along and beyond the panel and, in a pressed-in position, bearing by its internal end against the panel.

The present invention relates to a shelving unit or shelf for supporting articles, intended to be fixed or mounted, advantageously removably, in the chassis of a cabinet unit. In particular, it relates to a shelving unit able to be used in refrigerated compartments, such as refrigerated cabinets, refrigerating appliances, refrigerators, to support articles, in particular foodstuffs.

These shelving units comprise solid plates made of mineral or organic glass such as polycarbonate or poly(methyl methacrylate), monolithic or laminated, transparent, translucent or opaque, provided with a surround, total or partial, made of plastic material so as to avoid the risks of wounds from the sharp edges of the plates and/or to reinforce said plates.

Moreover, the edges of the surround made of plastic material can be straight and uniform or of more complex shape, being able in particular to present peripheral parts or extensions for functional or esthetic purposes. Thus, the front edge can form a handle for manipulating the shelving unit and the side and rear edges are generally adapted to cooperate with the chassis of the cabinet unit, which generally bears shelving support strips.

There are various methods of joining the surround made of plastic material to the panel, by encapsulation molding, or by adding a surround to the panel, for example by gluing, clipping or fitting sides of the surround or even by shrink-fitting the surround just after molding, the panel in this case being joined to the surround on leaving the mold before the plastic material has fully shrunk.

These shelving units give satisfaction by their practical and esthetic forms, and also by the fact that the joining methods, in particular by shrinkage, make it possible to obtain a good connection and, if necessary, a good seal-tightness between the glass panel and the surround made of plastic material.

The present invention addresses the shelving units for which the surround made of plastic material grips the rims of the panel, in particular by shrinkage, such shelving units having been described by the filing company in the international PCT applications WO 02/076268 Al and WO 2006 059038 A1.

The surrounds of the shelving units described in this way comprise at least one flange towards the inside applied to the panel supporting articles on at least one of the two faces of said panel. In practice, a flange towards the inside is applied to all the perimeter of the top face of the panel, considered in the position of use. In this way, if liquid flows from foodstuffs positioned on the shelving unit, it is retained by the end vertical edge of this flange. Also, under the bottom face of the panel concerned in the position of use, a number of flanges of the surround are applied, taking the form of securing tabs distributed all around the perimeter of the panel.

In reality, it would be possible to do without these securing tabs, in particular in the case where the frame is applied to the panel by shrinkage, but it is preferable to provide them for safety reasons.

Thus, during manufacture, these securing tabs, produced by molding with the surround of the panel, prove to be a hindrance.

In certain cases, the panel can be put in place without touching said tabs, in particular if the putting-into-place occurs very quickly after leaving the mold and therefore in a period when the frame is not yet in actual fact shrunk. In other cases, the manufacture of the shelving unit entails handling that is all the more difficult because the frame is hotter; this therefore means that automating the insertion of the glass panel into the frame made of plastic material is not possible.

The aim of the present invention is to remedy these drawbacks. To this end, provision is made for the securing of the panel under its bottom face to be performed by parts added by the operator, once the panel has been inserted into the frame. This insertion of the panel into the frame is performed without difficulty because of the absence of the abovementioned flanges, and can therefore be automated.

The subject of the present invention is therefore in the first place a shelving unit for a cabinet, in particular for a refrigerator or similar, comprising a panel supporting articles and a frame or part of a frame gripping the panel by its actual surrounding part, said frame being arranged to allow said shelving unit to be mounted in the chassis of said cabinet, characterized in that at least one securing member for the panel is provided in its bottom part, said securing member comprising a rider (or strap) able to overlap a protuberance or rib of the frame, extending along and (overhanging) beyond the panel and, in the pressed-in position, bearing by its internal end against the panel.

The protuberance or rib is advantageously formed, continuously or discontinuously, over all the perimeter of the frame.

The riders can be able to be positioned at points of the perimeter of the frame selected by the user.

Each rider can include internally a snap-fitting dog able to be positioned in a hole formed in said protuberance or rib. The holes can then be advantageously distributed over the perimeter of the frame.

According to a particular embodiment, each rider can consist of a part made of plastic material including a bottom to which are connected two branches, the distance between which corresponds to the thickness of the rib or protuberance, the internal branch bearing by its free edge on the panel and the external branch being able to support a dog for snap-fitting the rider onto the protuberance.

According to a particular embodiment, the two wings of the riders can be pierced with facing holes, and holes can also be pierced in the ribs at a level such that a key introduced into the holes of the riders passes through the hole in the rib and immobilizes the rider on the rib. In this case, the key can itself have pierced the hole in the rib, given that the operation was carried out when the frame was still hot. The key can have been pressed in before cooling and shrinkage were complete.

A rider can in particular have the general form of a cylindrical pin or have the general form of a hook.

A rider can also have a length equal to all or part of the perimeter formed by the ribs surrounding the panel.

The present invention also relates to a method of manufacturing a shelving unit as defined hereinabove, characterized in that it comprises steps consisting in:
placing on a support the frame or the part of frame leaving the mold in the still-hot state, the frame being placed on its face that will be the top face in the position of use;
inserting the panel into the frame or the part of the frame still in the hot state;
leaving the frame to shrink at least partially;
fixing to the frame the panel securing member or members and, where appropriate, leaving the frame to finish shrinking.

Finally, the present invention relates to a cabinet unit, such as a refrigerated cabinet, refrigerating appliance or refrigerator comprising at least one shelving unit as defined hereinabove.

To better illustrate the shelving unit as claimed by the present invention, a particular embodiment thereof is described hereinbelow, with reference to the appended drawing.

In this drawing:

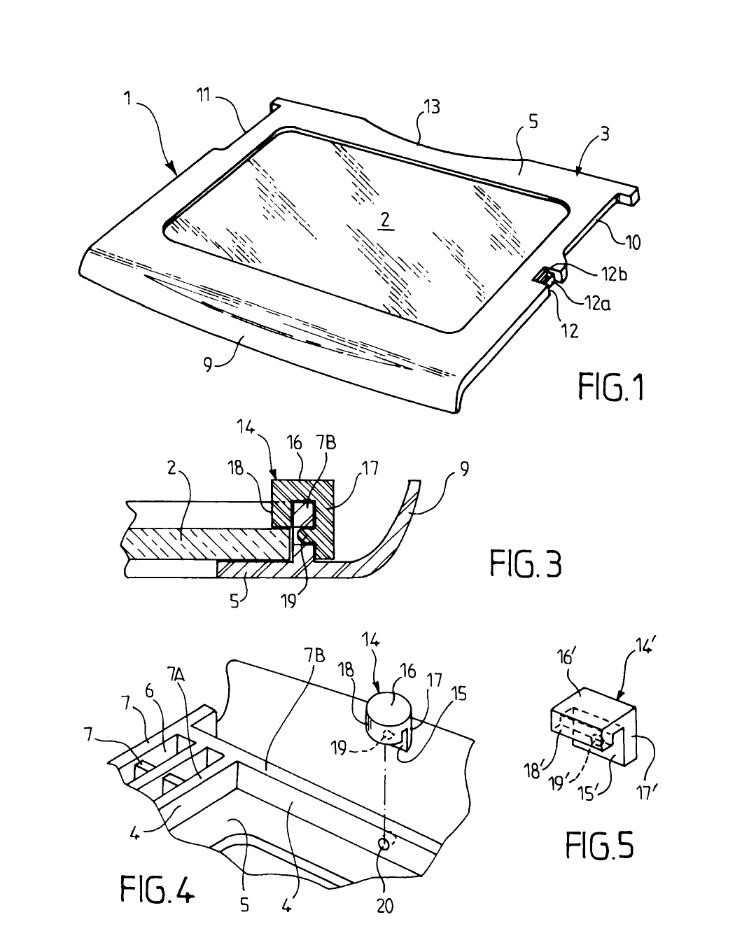

FIG. 1 is a perspective view of the shelving unit according to the present invention, showing the top face of the latter in the position of use;

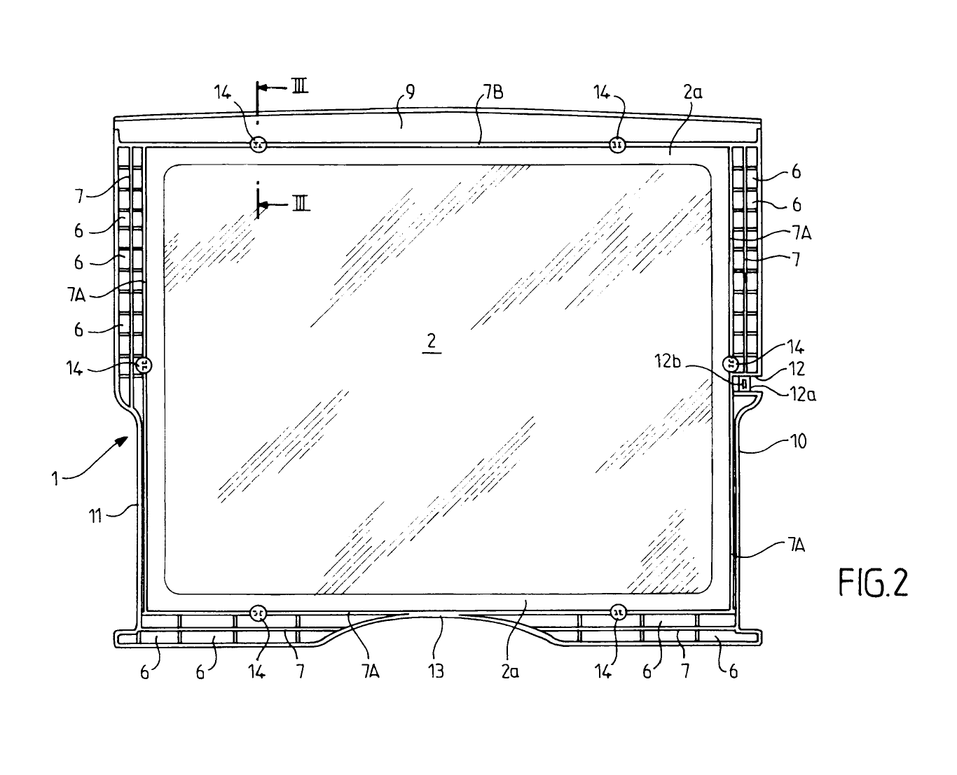

FIG. 2 is, on a larger scale, a bottom view of the shelving unit of FIG. 1, equipped with securing means according to the present invention;

FIG. 3 is, on an even larger scale, a cross- sectional view through III-III of FIG. 2;

FIG. 4 is a partial exploded perspective view of the region of FIG. 2 located in the top left corner when looking at this figure, the glass panel not, however, having been represented in this figure; and

FIG. 5 shows, in perspective, a variant embodiment of the securing means represented in FIGS. 3 and 4.

Referring to FIGS. 1 and 2, it can be seen that a shelving unit 1 for a refrigerator is represented. In the description that follows of this unit, the terms “front”, “rear”, “right”, “left”, “bottom”, “top”, “vertical”, “horizontal” and equivalent expressions will be used with reference to their position in place inside a refrigerator, with the user facing the shelving unit concerned.

The shelving unit 1 comprises a mineral or organic glass panel 2, rectangular, provided with a frame 3 made of a relatively rigid plastic material, such as polypropylene.

The frame 3, of generally rectangular and flattened form, comprises a surround part proper, having a vertical internal wall 4, rectangular, of a height greater than the thickness of the glass panel 2 and gripping the latter over its entire thickness in the mounting position. The distance between the wall 4 and the rim of the glass panel 2 is reduced, to zero in particular, at least in certain places, which results from the chosen manufacturing method which will be described later. This fixing method ensures that the mounting is secure and seal-tight.

In its top part and over its entire perimeter, the frame 3 forms a flange 5 towards the inside, of small thickness, which is applied to the top face of the glass panel 2, its free edge forming, for example, a rectangle with rounded corners (FIG. 1). The top face of the flange 5 is located in the extension of the top face of the actual surround of the frame 3, in order to form a perfectly smooth frame top 3. The bottom face of the glass panel 2 can be provided with an enameled edge 2a for example corresponding to the top flange 5 (FIG. 2).

The bottom face of the frame 3 is not smooth like the top face, but has, in its right and left rear edge regions, cells 6 separated by ribs 7, which makes it possible to save on material in these regions while maintaining sufficient rigidity for the frame 3. These cells 6 and ribs 7 can be obtained by the technique known as air molding.

Such ribs 7 are located at the internal edge of the rear, right and left regions, their internal vertical faces merging with the internal edge face 4 of the surround of the frame 3. These surround ribs are denoted 7A in the drawing and form a frame with a rib 7B of the same type formed along the internal edge of the front region of the frame 3.

To complete the description of the shelving unit 1, it can be indicated that:
the frame 3 is, for example, folded downward in its front part at 9 in order to form a handle for manipulating the shelving unit 1;
the right and left edges of the shelving unit 1 have, for example, in the rear region, elongate notches with curved edges respectively 10 and 11, the right edge also having in its central part a U-shaped notch 12, the bottom of which has a rib 12a provided with a central hole 12b of axis parallel to the internal edge 4 of the frame 3;
the rear edge of the shelving unit 1 has a central notch 13 in arc of circle form.

The role of these particularly-shaped cutouts in the edges of the shelving unit 1 depends on the chassis and the support structure (such as support strip) of said shelving unit 1 in the refrigerator, and its method of insertion and removal (thus, it is commonplace to provide, for safety reasons, for the shelving unit not to be able to be fully withdrawn directly, it being first withdrawn over only a part of the latter). Since they are not a concern of the present invention and only particular examples, these cutouts and details will not be described further here.

According to the present invention, members 14, of rider type, for securing the panel 2 to the bottom part of the latter are provided. Such a securing member is represented in FIGS. 3 and 4. It consists of a small cylindrical part, made of relatively flexible plastic material, having a diametrical slot 15 over all of its height, the width of the slot being equal to or very slightly greater than the thickness of the ribs 7A, 7B. A flat bottom 16 in the form of a disk is thus formed, to one face of which connect two skirts 17, 18 in the form of parts of a cylinder, one of the skirts (18) however being shortened. The internal height of the skirt 18 is equal to or very slightly greater than the height of the part of rib 7A, 7B extending beyond the panel 2 in the latter's mounting position. Moreover, the skirt 17 bears, in its part extending beyond the skirt 18, a dog 19 directed internally, the role of which is indicated below.

The riders 14 are intended to overlap the ribs 7A, 7B in points of the latter provided for this purpose—six of them in the example illustrated: one on each right and left edge and two on each front and rear edge—where through-holes 20 are formed perpendicularly to the mean plane of said ribs 7A, 7B. When a rider 14 is inserted by clamping, the rider being offered up above a rib 7A, 7B with its skirt 18 facing internally, the skirts 17 and 18 are slightly separated for the dog 19 to pass, the latter being positioned by snap-fitting in the corresponding hole 20 and the edge of the skirt 18 bearing against the panel 2.

FIG. 5 shows a rider 14′ consisting of a variant embodiment of the rider 14. The rider 14′ is no longer of pin type like the rider 14 but of hook type. It consists of a U-shaped part, made of relatively flexible plastic material, including a core 16′ and two wings 17′ and 18′, the wing 18′ being shortened in the same way as the skirt 18. The space 15′ between the two wings 17′, 18′ corresponds to the slot 15 and the wing 17 bears at its center a dog 19′ similar to the dog 19.

Hooks 14′ are fixed to the ribs 7A, 7B in the same way as the pins 14, the skirts 18′ bearing on the panel 2.

In a variant, the two walls 17′ and 18′ are pierced with holes facing each other, holes at the same height are provided in the ribs 7A, 7B and the hooks 14′ are put in place on the ribs 7A, 7B in such a way that the various holes coincide, a key inserted into the holes immobilizing the rider on the rib. Given that the key is put in place before the frame is fully shrunk, the continuing shrinkage shall contract the hole pierced in the rib and therefore firmly grip said key.

The shelving unit 1 that has just been described is obtained by formation of the frame 3 made of plastic material by hot molding, the glass panel 2 being joined to the frame 3 on leaving the mold before the plastic material has fully shrunk. Details concerning this method (temperatures, step times, etc.) will be found in the international PCT application WO 02/076268 A1 in the name of the filing company.

For the mounting of the shelving unit 1, the frame 3, still hot, is placed on a support by its face comprising the flange 5 (top face in the position of use), and the panel 2 is put in place before the frame is fully shrunk. Positioning is easy, because the frame 3 has no flange on its bottom face.

A perfect joining of the assembly is obtained in this way, because the panel 2 is gripped by the frame 3 in a seal-tight manner. This is of great practical importance, since the shelving unit 1 is intended to support foodstuffs which can spill and slip into plastic-glass material junction areas, prejudicing the correct use of the refrigerator.

The assembly is then reinforced by the placement, as described above, of at least one securing member 14, 14′. This placement is generally performed once the frame 3 is in its position gripping the panel 2.

Obviously, the embodiments that have just been described have been given as a non-limiting indication and modifications can be made without in any way departing from the context of the present invention. Notably, in a variant, the riders have a substantial length, even forming one or more angles, and overlap all or part of the perimeter of ribs framing the glass panel.

1-14. (canceled)

15. A shelving unit for a cabinet, a refrigerator, or similar cabinet, comprising:
a panel supporting articles and a frame or part of a frame gripping the panel by its actual surrounding part, the frame configured to allow the shelving unit to be mounted in a chassis of the cabinet; and
at least one securing member for the panel provided in its bottom part, the securing member comprising a rider configured to overlap a protuberance or rib of the frame, extending along and beyond the panel and, in a pressed-in position, bearing by its internal end against the panel.

16. The shelving unit as claimed in claim 15, wherein the protuberance or rib is formed, continuously or discontinuously, over all a perimeter of the frame.

17. The shelving unit as claimed in claim 15, wherein the riders are configured to be positioned at points of a perimeter of the frame selected by a user.

18. The shelving unit as claimed in claim 15, wherein each rider includes internally a snap-fitting dog configured to be positioned in a hole formed in the protuberance or rib.

19. The shelving unit as claimed in claim 18, wherein the holes are distributed over the perimeter of the frame.

20. The shelving unit as claimed in claim 15, wherein each rider includes a part made of plastic material including a bottom to which are connected two branches, a distance between which corresponds to the thickness of the rib or protuberance, an internal branch bearing by its free edge on the panel and an external branch configured to support a dog for snap-fitting the rider onto the rib or protuberance.

21. The shelving unit as claimed in claim 15, wherein two wings of the riders are pierced with facing holes, and holes are also pierced in the ribs at a level such that a key introduced into the holes of the riders passes through the hole in the rib and immobilizes the rider on the rib.

22. The shelving unit as claimed in claim 21, wherein the key has itself pierced the hole in the rib, given that the operation was carried out when the frame was still hot.

23. The shelving unit as claimed in claim 21, wherein the key has been pressed in before cooling and shrinkage are complete.

24. The shelving unit as claimed in claim 20, wherein the rider has a general form of a cylindrical pin.

25. The shelving unit as claimed in claim 20, wherein the rider has a general form of a hook.

26. The shelving unit as claimed in claim 15, wherein a rider has a length equal to all or part of the perimeter formed by the ribs surrounding the panel.

27. A method of manufacturing the shelving unit as defined in claim 15, comprising:
placing on a support the frame or the part of frame leaving a mold in a still-hot state, the frame being placed on its face that will be a top face in the position of use;
inserting the panel into the frame or the part of the frame still in the hot state;
leaving the frame to shrink at least partially;
fixing to the frame the panel securing member or members and, where appropriate, leaving the frame to finish shrinking.

28. A cabinet unit, a refrigerated cabinet, refrigerating appliance, or refrigerator comprising at least one shelving unit as defined in claim 15.
